(19) United States
(12) Patent Application Publication
(10) Pub. No.: US 2005/0066048 A1
(43) Pub. Date: Mar. 24, 2005

(54) Web-based music distribution system and method therefor

(76) Inventor: Bruce Young, LeMars, IA (US)

Correspondence Address: SUITER- WEST PC LLC, 14301, FNB PARKWAY SUITE 320, OMAHA, NE, 68154, US

(21) Appl. No.: 10/646,156

(22) Filed: Aug. 22, 2003

(51) Int. Cl. G06F 15/16

(52) U.S. Cl. 709/231

(57) ABSTRACT

The present invention is a method and system for distributing archival content. Streaming content may be broadcast to a list of users. When a user desires to store a particular piece of content, the particular piece of content in an archival format may be delivered to a storage media of the user. Each user may register for customized service in which the registration lists the user's content preferences. Content in conformity with the user's preferences may be broadcast in a streaming content format to the user. This may allow the user to purchase and/or store desirable content selections in an easier fashion as all of the content selections broadcast to the user may be in conformity with the user's preferences.

### FIELD OF THE INVENTION

The present invention generally relates to the field of data transfer, and more particularly to a system and method for online selling of desirable content to customers.

### BACKGROUND OF THE INVENTION

The retrieval and compilation of music and video files has become extremely popular among individuals. Currently, many online businesses provide subscription-based and fee-based retrieval of media content. This is advantageous as it allows consumers to produce content sets in which each content selection is desirable for the consumer.

However, it is often inconvenient for a consumer to determine desirable musical selections. A great deal of time and effort may be expended by listening to musical selections from an online distributor and determining whether to purchase the particular selection. It would be advantageous if a user could listen or watch content selections via a streaming media format, similar to a conventional radio setting, and if a user likes a particular selection, retrieve the content selection in a format suitable for archival use. Consequently, a method and system for distributing archival content by transforming streaming content is necessary.

### SUMMARY OF THE INVENTION

Accordingly, the present invention is directed to a method and system for distributing content. In an embodiment of the invention, streaming content may be broadcast to a list of one or more subscribers. Upon receipt of a request from a subscriber to store a particular piece of content that has been broadcast, content in an archival format that allows storage of the content may be provided to the subscriber. In an advantageous aspect of the present invention, the archival format content may be provided in real-time with the transmission of the content in streaming content format.

In a second aspect of the invention, a user may subscribe to an online content distribution service of the present invention. The subscription may include a registration of the user that lists the user's content preferences. Content in conformity with the user's preferences may be broadcast in a streaming content format to the user. This may allow the user to purchase and/or store desirable content selections in an easier fashion as all of the content selections broadcast to the user may be in conformity with the user's preferences.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is depicts a system for distributing content in accordance with an embodiment of the present invention;

FIG. 2 is an embodiment of a process for distributing content through the broadcast of streaming content;

FIG. 3 is an alternative embodiment of a process for distributing content through the broadcast of streaming content; and

FIG. 4 is a block diagram of an information handling system of the present invention.

### DETAILED DESCRIPTION OF THE INVENTION

Reference will now be made in detail to the presently preferred embodiments of the invention, examples of which are illustrated in the accompanying drawings.

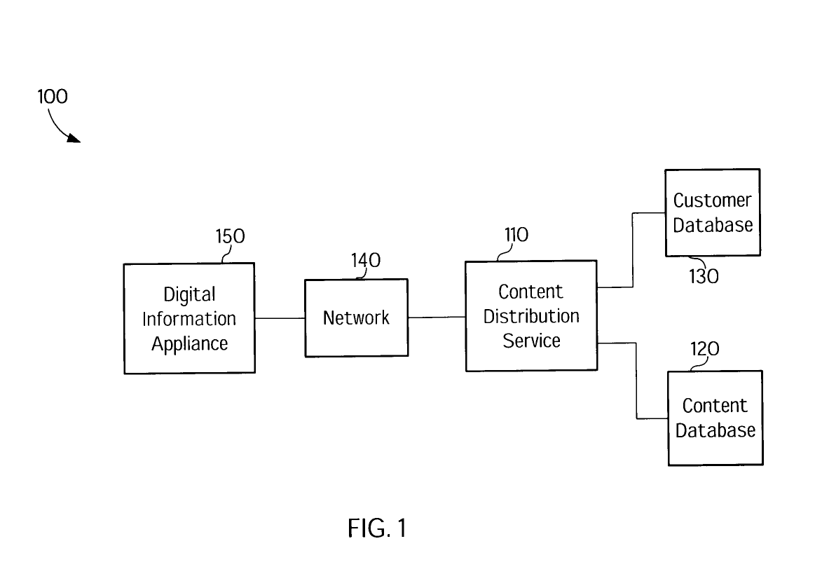

Referring to FIG. 1, a system 100 for distributing content in accordance with an embodiment of the present invention is shown. A content distribution service 110 of the present invention may be implemented by a host server including an information handling system. In one embodiment of the invention, online content distribution service may include a web site with streaming content capability. When content distribution service 110 provides streaming media, the streaming media may be in a format that may not be archived on a playing device. This is advantageous as it may prevent unauthorized copying and distribution of the content. Online content distribution service may access content database 120 to obtain content selections which may be broadcast to a user across a network 140 and received by a user by a digital information appliance 150. Content database may contain content in an archival format that allows storage of the content. Network 140 may be a digital broadcast medium. In one embodiment of the invention, network 140 may be the Internet. Digital information appliance may include any device capable of receiving and playing streaming content, including a personal computer, personal digital assistant, cellular telephone, web browser and the like.

When a user desires to store a particular content selection that is being broadcast via a streaming content broadcast, a request to store the content selection may be executed via digital information appliance 150. Execution of a request to store the content selection may be implemented by pressing a “record” button on a digital information appliance. Upon receipt of the request to store a content selection, content distribution service 110 may provide the particular piece of the content being broadcast in a streaming content format to the user in an archival format that allows storage of the content. The archival formatted content may be stored on the user's storage media. Advantageously the archival format may include content protection capability to prevent the content from being widely distributed in an illegal fashion. Another advantageous aspect of the present invention is the ability to purchase streaming content in a real-time fashion without the necessity of downloading it again in a different format.

Content distribution service 100 may also access a customer database 130. Customer database may include customer information, payment authorization information and a user's preferences. For example, a user may provide the genre of music he or she desires, particular musicians, a particular era and the like. From this information, content distribution service may cross reference content database 120 to allow streaming content broadcast of content to a user in conformity with the user's preferences. This is advantageous as it may allow the user to sample possible content selections desirable to the user for permanent storage. In another embodiment of the invention, particular “stations” may be broadcast to the users that are similar in style to the user's preferences.

Payment of content selections that are stored may be effectuated in several ways. For example, a user may pre-pay for a certain amount of content and this information may be stored with the customer information or may be stored within the digital information appliance. When a user decides to purchase a content selection, the purchase may be debited against the pre-paid credit. In another embodiment, an account may be created and stored within the web site of the content distribution service 110. A user may log in to the service when the user wishes to receive streaming content from the content distribution service. When a user may a purchase for a content selection, a charge against a credit card may be implemented.

It should be understood that FIG. 1 may depict exemplary functional aspects of the invention which may be implemented to provide the overall functionality described. It is contemplated that the system 100 for distributing content may be implemented in various ways by those with ordinary skill in the art without departing from the scope and spirit of the present invention.

As stated, content may be broadcast by the content distribution service in a streaming content format. Streaming refers to the ability to distribute “continuous” digital content over networks in real time in much the way that content is transmitted in real time over conventional broadcast networks. Streaming content is not stored permanently, but rather is only stored temporarily, only long enough for that section of the content to be played.

Streaming content may operate through a continuous broadcast that employs an encoder, server, and player. The encoder converts audio content, stored in an archival format in content database 120, to a streaming content format. A personal computer, server, or the like makes the streaming content available over a network 140, such as the Internet. A player retrieves the content. Examples of players may include RealOne ™ by Real Networks, Inc. and Windows Media Player ™ by the Microsoft Corporation.

Streaming content may be multicast to a large audience or may be sent to a single user, i.e. a unicast. An advantageous aspect of streaming is that it has been designed to accommodate the protection of ownership and reproduction rights for digital content owners. Content owners may directly control which viewers or subscribers have the right to watch or listen to the content.

For example, unless authorized by the content provider, streamed content may not be easily recorded, thus storage is prevented. It is well known to the art to employ subscriber management systems, in conjunction with streaming content players, to prevent the storage of streamed content. In an advantageous aspect of the present invention, the subscribers to the content distribution service 110 of the present invention may only be able to listen to the content but may be prevented from storing the content distributed in a streaming content format.

An archival format may refer to a digital file that may allow storage of the file in a memory. It is well known in the art that Motion Pictures Expert Group Layer 3, (MP3) is a popular archival format type that may be used to store audio data for later playing. Additionally, another type of archival format may be Windows Media Application™ (WMA). The archival format preferably may include content protection capability as included in WMA to prevent the content from being widely distributed in an illegal fashion. Consequently, when a user desires to store a particular piece of content that is currently being broadcast in a streaming content format, the user may initiate a request to purchase the piece of content. When the content distribution service 110 receives the request, the particular piece of content may be delivered to the storage media of the user in real time.

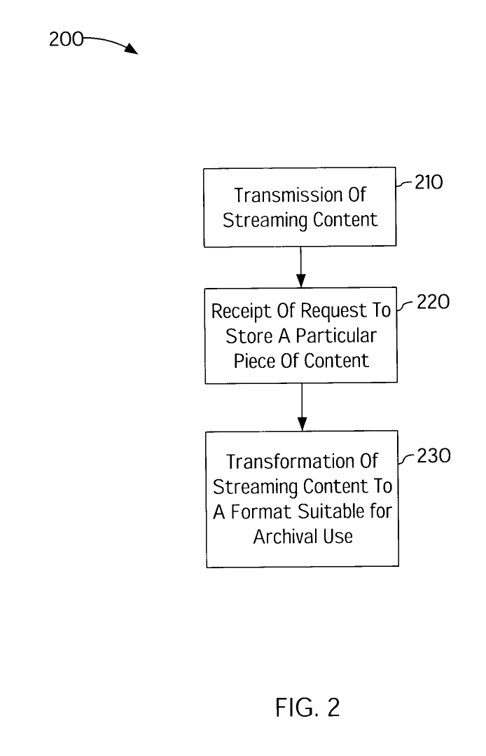

Referring now to FIG. 2, an embodiment of a process 200 for distributing content in accordance with an embodiment of the invention is shown. Process 200 of the present invention may be executed by content distribution service 110 of FIG. 1. Process 200 may begin upon the transmission of streaming content 210. The streaming content may be in a form that may not be archived on a playing device. For example, streaming content may be in the form of a RealAudio format.

When a user decides to purchase a content selection, content distribution service 110 of FIG. 1 may receive the request to store a particular piece of content 220. When the request is received, payment information may be retrieved to determine if the transaction may be approved. After approval, the piece of content may be delivered to the user in an archival format that allows storage of the content on the user's storage media. 230. Receipt of the request to store a piece of content and delivery of the content to the user may occur in real-time of the transmission of the piece of content.

It is contemplated that storage of the content by the content distribution service 110 of FIG. 1 may be in one type of archival format whereby the user desires another type of archival format. For example, In one embodiment of the invention, the content distribution service may store the content in accordance with Motion Pictures Entertainment Group Layer 3, (MP3) specifications and the user desires the archival format to be Windows Media Application (WMA) as noted by the user's subscription. In such a scenario, content distribution service 110 may transcode the particular piece of content to the type of archival format desired by the user. The archival format, regardless of the type, may preferably include content protection capability as included in WMA to prevent the content from being widely distributed in an illegal fashion.

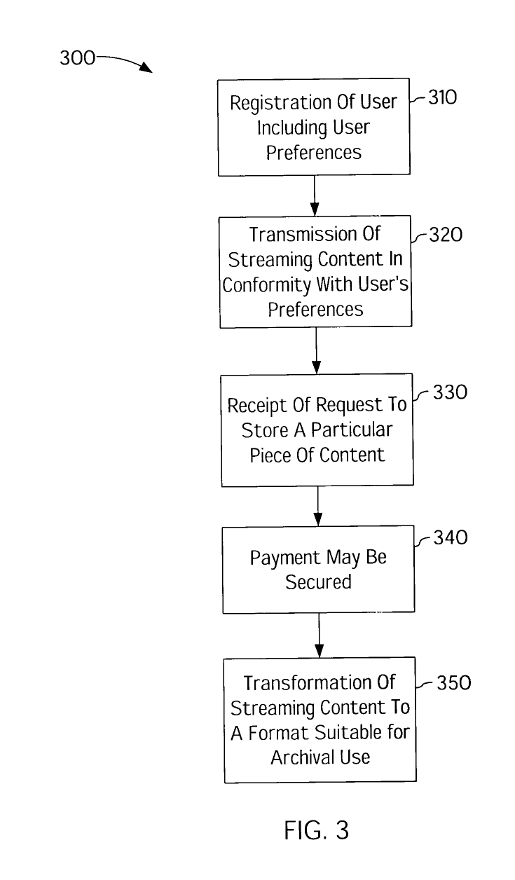

Referring now to FIG. 3, an alternative embodiment of a process 300 for distributing content in accordance with the present invention is shown. Process 300 of the present invention may be executed by content distribution service 110 of FIG. 1. Process 300 may begin upon retrieving the registration of a user include a user's preferences. Receipt of the registration may be executed when a user logs in to the content distribution service 110 of FIG. 1 of the present invention. Streaming content in conformity with the user's preferences may be transmitted to the user 320. The streaming content may be in a form that may not be archived on a playing device, for example, prevents storage of the content. For example, streaming content may be in the form of a RealAudio format.

When a user decides to purchase a content selection, content distribution service 110 of FIG. 1 may receive the request to store a particular piece of content 330. When the request is received, payment information may be retrieved to determine if the transaction may be approved. When payment is secured 340, the piece of content may be delivered to the user in an archival format that allows storage of the content on the user's storage media. 350. Receipt of the request to store a piece of content and delivery of the archival formatted content format may occur in real-time of the transmission of the piece of content. In one embodiment of the invention, the format suitable for archival use may be Motion Pictures Entertainment Group Layer 3, (MP3). In an alternative embodiment, the format suitable for archival user may be Windows Media Application (WMA). The archival format preferably may include content protection capability as included in WMA to prevent the content from being widely distributed in an illegal fashion.

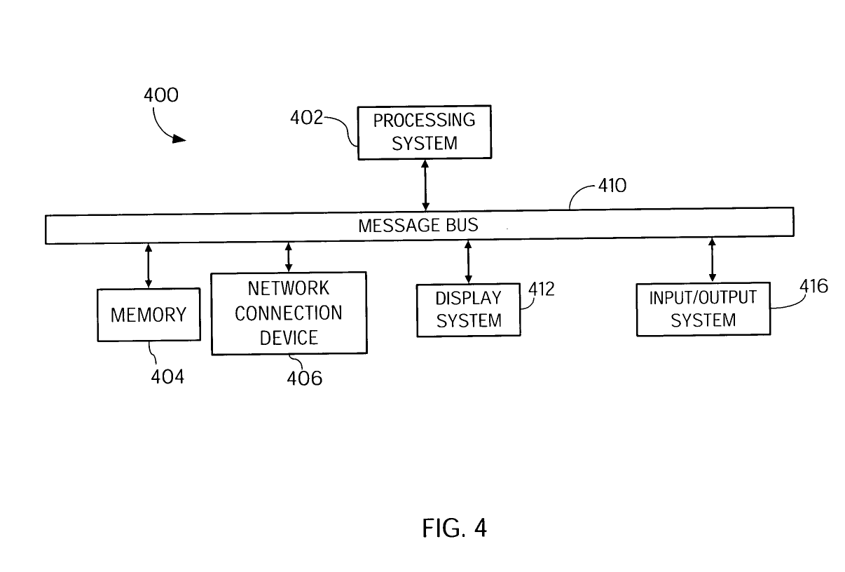

Referring now to FIG. 4, a hardware system in accordance with the present invention is shown. The hardware system shown in FIG. 4 is generally representative of a preferred hardware architecture of an information handling system 400 for implementing the content distribution service 110 of FIG. 1 of the present invention. In one embodiment of the invention, information handling system 400 may be capable of performing processes 200 and 300 of the present invention depicted in FIGS. 2-3. For example, steps of processes 200 and 300 may be implemented as a program of instructions executable by information handling system 400. A controller, for example, a processing system 402, controls the information handling system 400. The processing system 402 includes a central processing unit such as a microprocessor or microcontroller for executing programs, performing data manipulations and controlling the tasks of the information handling system 400. Communication with the processing system 402 may be implemented through a message or system bus 410 for transferring information among the devices of the information handling system 400. The system bus 410 may include a data channel for facilitating information transfer between storage and other peripheral devices of the information handling system 400. The system bus 410 further provides the set of signals required for communication with processing system 402 including a data bus, address bus, and control bus. The system bus 410 may comprise any state of the art bus architecture according to promulgated standards, for example industry standard architecture (ISA), extended industry standard architecture (EISA), Micro Channel Architecture (MCA), peripheral device interconnect (PCI) local bus, standards promulgated by the Institute of Electrical and Electronics Engineers (IEEE) including IEEE 488 general-purpose interface bus (GPIB), IEEE 696/S-600, and so on. Furthermore, the system bus 410 may be compliant with any promulgated industry standard. For example, the system bus 410 may be designed in compliance with any of the following bus architectures: Industry Standard Architecture (ISA), Extended Industry Standard Architecture (EISA), Micro Channel Architecture, Peripheral Device Interconnect (PCI), Universal Serial Bus (USB), Access bus, IEEE P6394, Apple Desktop Bus (ADB), Concentration Highway Interface (CHI), Fire Wire, Geo Port, or Small Computer Systems Interface (SCSI), as examples.

Additionally, the information handling system 400 includes a memory 404. In one embodiment, memory 404 is provided on SIMMs (Single In-line Memory Modules), while in another embodiment, memory 404 is provided on DIMMs (Dual In-line Memory Modules), each of which plugs into suitable sockets provided on a motherboard holding many of the other devices shown in FIG. 4. Memory 404 includes standard DRAM (Dynamic Random-Access Memory), EDO (Extended Data Out) DRAM, SDRAM (Synchronous DRAM), or other suitable memory technology. Memory 404 may also include auxiliary memory to provide storage of instructions and data that are loaded into the memory 404 before execution. Auxiliary memory may include semiconductor based memory such as read-only memory (ROM), programmable read-only memory (PROM) erasable programmable read-only memory (EPROM), electrically erasable read-only memory (EEPROM), or flash memory (block oriented memory similar to EEPROM).

The information handling system 400 may include a network connection device or a network interface 406. The network interface 406 communicates between the information handling system 400 and a remote device, such as external devices, networks, information sources, or host systems that administer a plurality of information appliances. For example, host systems such as a server or information handling system, may run software controlling the information handling system 400, serve as storage for an information handling system 400, or coordinate software running separately on each information handling system 400. The network interface 406 may provide or receive analog, digital, or radio frequency data. The network interface system 406 preferably implements industry promulgated architecture standards, including Recommended Standard 232 (RS-232) promulgated by the Electrical Industries Association, Infrared Data Association (IrDA) standards, Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, 802.66 for wireless networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and Universal Serial Bus (USB), as examples. For example, the network interface system 406 may comprise a network adapter, a serial port, parallel port, printer adapter, modem, universal asynchronous receiver-transmitter (UART) port, etc., or use various wireless technologies or links such as an infrared port, radio-frequency (RF) communications adapter, infrared transducers, or RF modem.

The information handling system 400 may preferably include a display system 412. This may allow for a generation of a display when an information handling system 400 is connected to a display device. The display system 412 may comprise a video display adapter having all of the devices for driving the display device, including video random access memory (VRAM), buffer, and graphics engine as desired. A display device may comprise a liquid-crystal display (LCD), or may comprise alternative display technologies, such as a light-emitting diode (LED) display, gas or plasma display, or employ flat-screen technology.

An information handling system 400 may further include an input/output (I/O) system 416. This may allow for user input via I/O devices when I/O devices are connected to information handling system 400. Input/output system 416 may comprise one or more controllers or adapters for providing interface functions between one or more I/O devices. For example, input/output system 416 may comprise a serial port, parallel port, network adapter, printer adapter, radio-frequency (RF) communications adapter, universal asynchronous receiver-transmitter (UART) port, etc., for interfacing between corresponding I/O devices such as a mouse, joystick, trackball, trackpad, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, touch screen, stylus, electroacoustic transducer, microphone, speaker, etc. Some embodiments include a keypad scanning mechanism, or system, to interface to a dedicated array of buttons. It should be appreciated that modification or reconfiguration of the information handling system 400 of FIG. 4 by a person of ordinary skill in the art would not depart from the scope or the spirit of the present invention.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method for distributing content, comprising:
transmitting content in a streaming content format;
receiving a request to store a particular piece of the content; and
delivering said particular piece of the content in an archival format to a storage media of a user when request to store said particular piece of the content is received;
wherein said streaming content format prevents storage of the content;
wherein said archival format allows storage of the content; and
wherein said request and delivering of the particular piece of the content in said archival format occurs in real-time of transmission of the content in said streaming content format.

2. The method as claimed in claim 1, wherein said streaming content format is copy protected.

3. The method as claimed in claim 1, wherein said archival format is copy protected.

4. The method as claimed in claim 1, further comprising authorizing a payment for said request to store said particular piece of the content.

5. The method as claimed in claim 4, wherein authorizing said payment for said request includes debiting a charge against a prepayment for the content.

6. The method as claimed in claim 1, wherein the content transmitted in said streaming content format is in conformity with a list of preferences of said user.

7. A system for distributing content, comprising:
means for transmitting content in a streaming content format;
means for receiving a request to store a particular piece of the content; and
means for delivering said particular piece of content in an archival format to a storage media of a user when said request to store said particular piece of the content is received;
wherein said streaming content format prevents storage of the content;
wherein said archival format allows storage of the content; and
wherein said request and delivery of said particular piece of the content in said archival format occurs in real-time of transmission of content in said streaming content format.

8. The system as claimed in claim 7, wherein said streaming content format is copy protected.

9. The system as claimed in claim 7, wherein said archival format is copy protected.

10. The system as claimed in claim 7, further comprising means for authorizing a payment for said request to store said particular piece of the content.

11. The system as claimed in claim 7, wherein the content transmitted in said streaming content format is in conformity with a list of preferences of said user.

12. A method for distributing content, comprising:
retrieving a list of preferences of a particular user;
transmitting content in conformity with said list of preferences in a streaming content format to said particular user;
receiving a request to store a particular piece of the content; and
delivering the particular piece of content in an archival format to a storage media of said particular user when said request to store said particular piece of the content is received;
wherein said streaming content format prevents storage of the content;
wherein said archival format allows storage of the content; and
wherein said request and delivering of the particular piece of the content in said archival format occurs in real-time of transmission of the content in said streaming content format.

13. The method as claimed in claim 12, wherein said streaming content format is copy protected.

14. The method as claimed in claim 12, wherein said archival format is copy protected.

15. The method as claimed in claim 12, further comprising authorizing a payment for said request to store said particular piece of the content.

16. The method as claimed in claim 12, wherein authorizing said payment for said request includes debiting a charge against a prepayment for the content.

17. The method as claimed in claim 12, wherein said particular piece of the content is a song.

18. The method as claimed in claim 12, wherein said archival format includes MP3 format.
